(19) United States
(12) Patent Application Publication
(10) Pub. No.: US 2019/0366531 A1
(43) Pub. Date: Dec. 5, 2019

(54) ANTI-THEFT SOCKET FIXING SEAT

(71) Applicant: CHAO-MING HU, Taichung City (TW)

(72) Inventor: CHAO-MING HU, Taichung City (TW)

(21) Appl. No.: 15/993,670

(22) Filed: May 31, 2018

(51) Int. Cl. B25H 3/00; F16B 2/04; F16B 2/14; A47F 7/00

(52) U.S. Cl. CPC B25H 3/006; A47F 7/00; F16B 2/14; F16B 2/04

(57) ABSTRACT

An anti-theft socket fixing seat includes a seat and a clamp member. The seat has one end provided with a hollow pillar, with a protrusion formed on the pillar, such that the protrusion is allowed to protrude and contract with respect to the pillar along a radial direction of the pillar. The pillar has a through hole passing through two ends of the seat. The clamp member passes through the through hole and includes a support portion and an operation portion. The operation portion has one end connected with the support portion and the other end exposed from the pillar. When the socket is mounted around the pillar, the operation portion is able to move the support portion to a pressing position in the through hole, such that the protrusion is engaged with an engagement groove of the socket, achieving an anti-theft function.

### BACKGROUND OF THE INVENTION

### 1. Field of the Invention

The present invention relates to socket fixing seats, and more particularly, to an anti-theft socket fixing seat.

### 2. Description of the Related Art

Socket is a well-known hand tool which is usually applied together with wrench tools. Conventionally, sockets in the store are simply placed in a basin, such that consumers are able to select and purchase the sockets. However, such displaying method is not aesthetically appealing. Moreover, the sockets placed in an open environment are easily stolen, causing a potential loss of the store.

To solve the issues above, blister packs or hanging packs for containing a single socket and displaying shelves for holding multiple sockets are therefore designed by the industry, such that sockets are able to be displayed in such manners to be sold in the stores or malls. However, such blister packs and displaying shelves are not theft-proof. As a result, the socket products may still be stolen.

### SUMMARY OF THE INVENTION

For improving the issues above, the present invention discloses an anti-theft socket fixing seat, with a clamp member passing through the seat and pulled to a pressing position with respect to the seat, achieving an anti-theft function.

For achieving the aforementioned objectives, an anti-theft socket fixing seat in accordance with an embodiment of the present invention is provided, comprising:

a seat having a hollow pillar disposed at one end of the seat, with a protrusion disposed at one side of the pillar, the protrusion protruding and contracting with respect to the pillar, the pillar comprising a through hole, the through hole passing through two ends of the seat; and

a clamp member passing through the through hole, the clamp member comprising a support portion and an operation portion, with an end of the operation portion connected with the support portion, and another end of the operation portion exposed from the pillar. When the socket is mounted around the pillar, the operation portion drives the support portion to move to a pressing portion in the through hole, such that the protrusion is engaged with an engagement groove of the socket, achieving an anti-theft function.

With a structural simplicity and convenience of operation, during the operation of the present invention, the clamp member is inserted through the seat to be exposed from one end of the pillar. Therefore, the support portion of the clamp member moves to the pressing position with respect to the seat, such that the protrusion of the pillar radially expands outward to be engaged with the engagement groove, realizing an anti-theft function of the present invention.

### BRIEF DESCRIPTION OF THE DRAWINGS

FIG. 1 is a perspective view of the seat and the clamp member in accordance with an embodiment of the present invention.

FIG. 2 is a schematic view illustrating the seat in accordance with an embodiment of the present invention combined with a display body.

FIG. 3 is a schematic view illustrating the seat fixing a socket in accordance with an embodiment of the present invention to a display body.

FIG. 4 is a cross-sectional view taken along 4-4 in FIG. 3, illustrating the combination of the socket and the display body.

FIG. 5 is a sectional view illustrating the clamp member passing through the seat in accordance with an embodiment of the present invention.

FIG. 6 is a schematic view illustrating the operation portion of the clamp member being twisted with respect to the support portion, with the support portion placed at the pressing position with respect to the seat.

FIG. 7 is a schematic view illustrating the socket being engaged with the seat to achieve an anti-theft status.

### DETAILED DESCRIPTION OF THE INVENTION

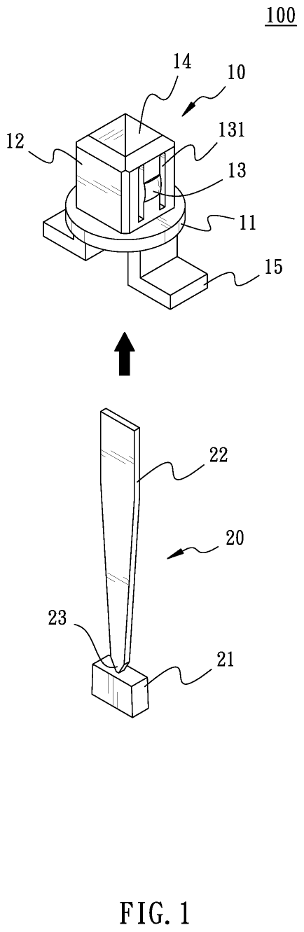

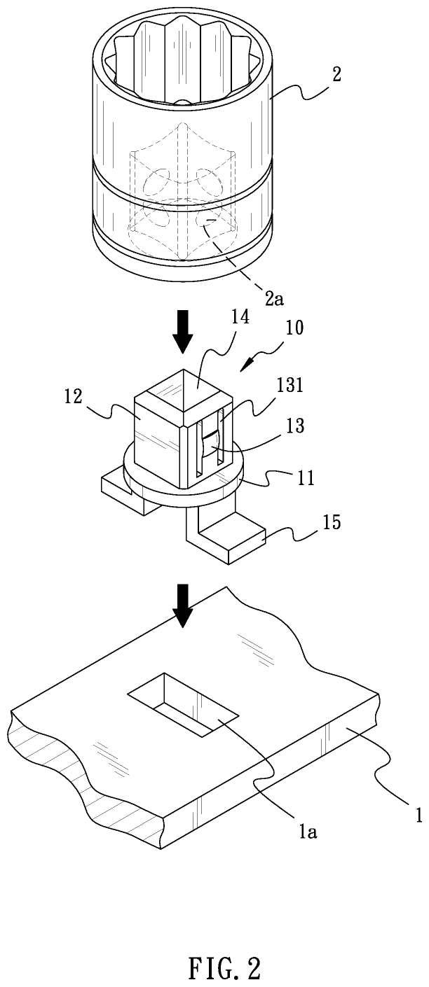

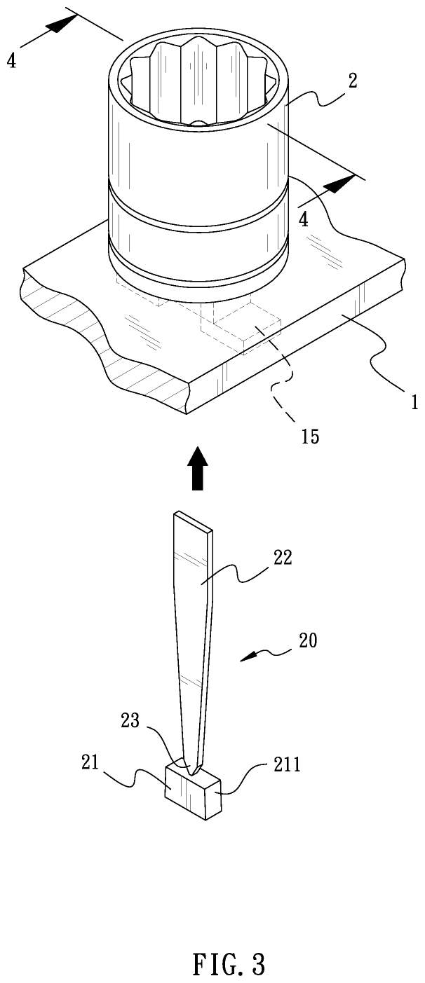

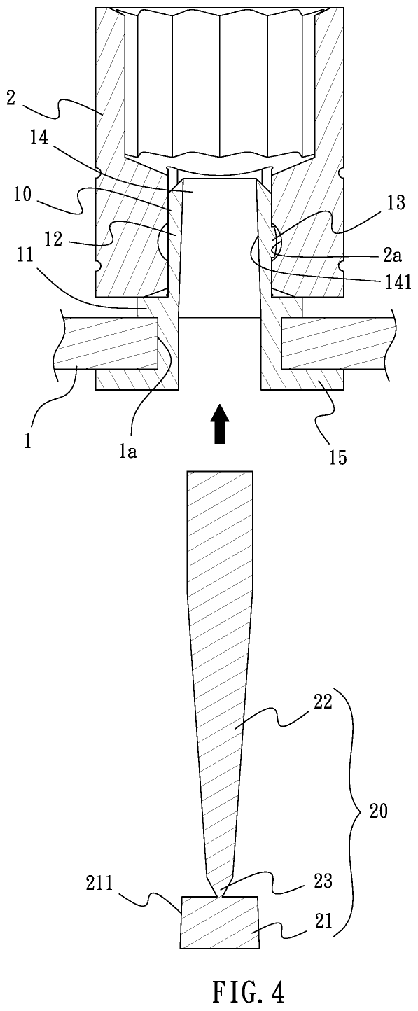

The aforementioned and further advantages and features of the present invention will be understood by reference to the description of the preferred embodiment in conjunction with the accompanying drawings where the components are illustrated based on a proportion for explanation but not subject to the actual component proportion. Embodiments of the present invention are illustrated in detail along with the drawings. However, the technical features included by the present invention are not limited to certain embodiments hereby provided. Scope of the present invention shall be referred to the claims, which include all the possible replacements, modifications, and equivalent features. Referring to FIG. 1 to FIG. 7, an anti-theft socket fixing seat 100 is provided, comprising a seat 10 and a clamp member 20. The seat 10 is allowed to be installed on a display body 1 for receiving a socket 2 (as shown by FIG. 4). When the clamp member 20 passes through the seat 10 and placed at a pressing portion, the seat 10 is engaged with the socket 2 to achieve the anti-theft function. The display body 1 is allowed to a blister pack, a displaying shelf, or a portion thereof.

The seat 10 has a base plate 11 for receiving the socket 2, as shown by FIG. 4, with a hollow pillar 12 extending from the base plate 11. In an embodiment of the present invention, the pillar 12 is formed in a rectangular column. A protrusion 13 is disposed on one side of the pillar 12 for being engaged with the engagement groove 2a on an inner face of the socket 2, as shown by FIG. 4. The pillar 12 comprises a through hole 14 passing through two ends of the seat 10, wherein the through hole 14 has a horizontal sectional face formed in a rectangular shape. Also, an elongate opening 131 is disposed on two sides of the protrusion 13 in an axial arrangement with respect to the pillar 12, respectively, wherein the two openings 131 are connected with the through hole 14, so as to enable the protrusion 13 to protrude and contract along a radial direction of the pillar 12.

Further, an installation portion 15 is disposed on one end of the seat 10 away from the pillar 12, such that the installation portion 15 is combined with the display body 1. In an embodiment of the present invention, the display body 1 comprises a bore 1a, and the installation portion 15 comprises two symmetrical foot members that are spaced with respect to each other, such that the two foot members are allowed to be compressed for resiliently installing the installation portion 15 being engaged with the bore 1a, so that the seat 10 is installed on the display body 1 for selling. It is noted that the display body 1 and the structures and the method for installing the seat 10 on the display body 1 are only for illustration of the embodiments instead of limiting the present invention.

The clamp member 20 passes through the through hole 14. The clamp member 20 comprises a support portion 21 and an operation portion 22, wherein the operation portion 22 has one end connected with the support portion 21. When the clamp member 20 passes through the through hole 14, an end of the operation portion 22 away from the support portion 21 is exposed from the pillar 12. In an embodiment of the present invention, the support portion 21 is a block having a horizontal sectional face formed in a rectangular shape, with an outer surface of the support portion 21 provided with an outer wall 211, which fits with an inner wall 141 of the through hole 14. The operation portion 22 is formed in an approximate elongate sheet, and connected with the support portion 21 via a connection portion 23. In an embodiment of the present invention, the support portion 21 and the operation portion 22 are integrally made of plastic material, wherein the sectional area of the junction between the connection portion 23 and the support portion 21 is the smallest portion of the overall sectional area of the clamp member 20. Therefore, the operation portion 22 is allowed to be twisted with respect to the support portion 21, such that the connection portion 23 is broken to separate the operation portion 22 from the support portion 21.

Also, the outer wall 211 tapers from a bottom end of the support portion 21 toward a top end of the support portion 21, wherein an edge of the outer wall 211 away from the connection portion 23 is wider than another edge of the outer wall 211 in adjacent to the connection portion 23. Therefore, when the clamp member 20 passes through the through hole 14 of the seat 10, with the operation portion 22 being pulled toward the pillar 12, the outer wall 211 of the support portion 21 fittingly contacts the inner wall 141 of the through hole 14 to be placed at the pressing position, so that the protrusion 13 radially expands to be engaged with the engagement groove 2a of the socket 2, achieving an anti-theft status on the selling site.

It is noted that, in an embodiment of the present invention, the operation portion 22 is driven by a pulling motion, such that the support portion 21 moves in the through hole 14 to the pressing position along the axial direction of the through hole 14. It is understood that the operation portion 22 is also allowed to be pushed to move the support portion 21 to the pressing position.

FIG. 4 to FIG. 7 illustrate the operation status of the present invention. First, the seat 10 is installed on the display body 1. Next, the socket 2 is mounted around the pillar 12 of the seat 10. At the meantime, the socket 2 is simply placed around the pillar 12; therefore, the socket 2 will still be detached from the seat 10 under a certain external force.

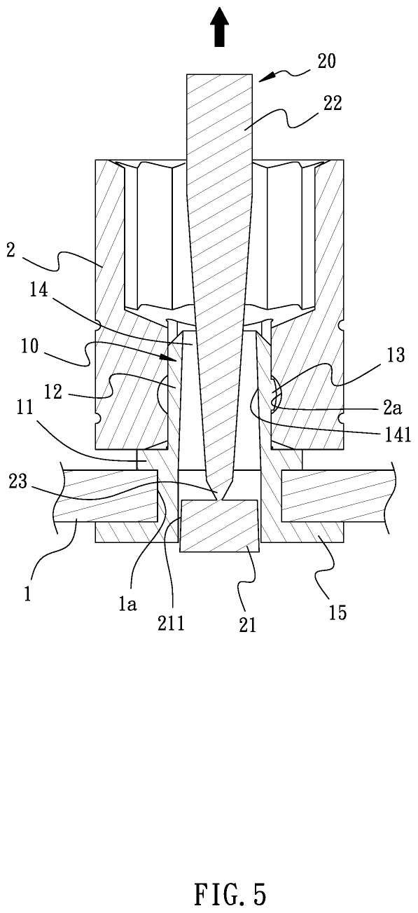

Referring to FIG. 5, then the clamp member 20 is inserted into the through hole 14 from the installation portion 15 of the seat 10, such that one end of the operation portion 22 away from the support portion 21 passes through the through hole 14 to be exposed from and end of the pillar 12 away from the installation portion 15.

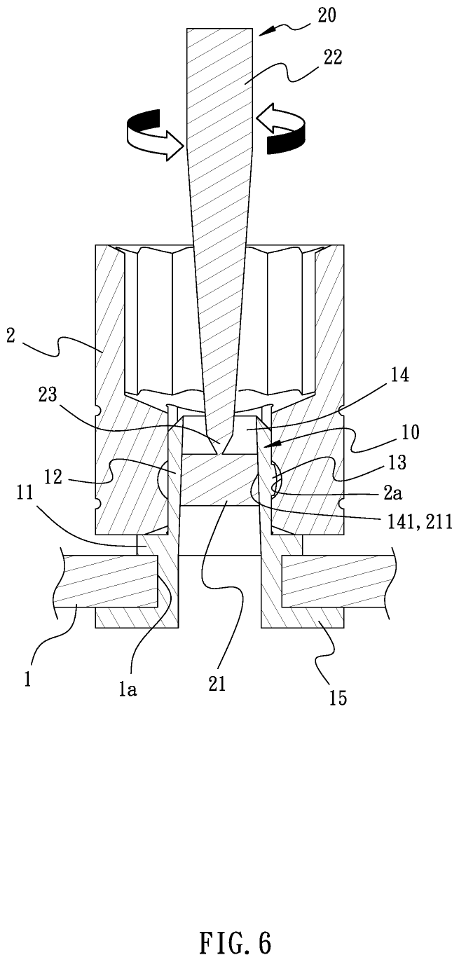

Referring to FIG. 6, for achieving the anti-theft function, the operation portion 22 of the clamp member 20 is pulled, so as to move the support portion 21 with respect to the seat 10 toward the pillar 12 until the outer wall 211 of the support portion 21 fitting matched with the inner wall 141 of the through hole 14 at the pressing portion. At the meantime, the inner lateral side of the protrusion 13 radial expands due to the pressing of the support portion 21, such that the protrusion 13 is stably engaged with the engagement groove 2a of the socket 2, thus preventing the socket 2 from being detached from the seat 10.

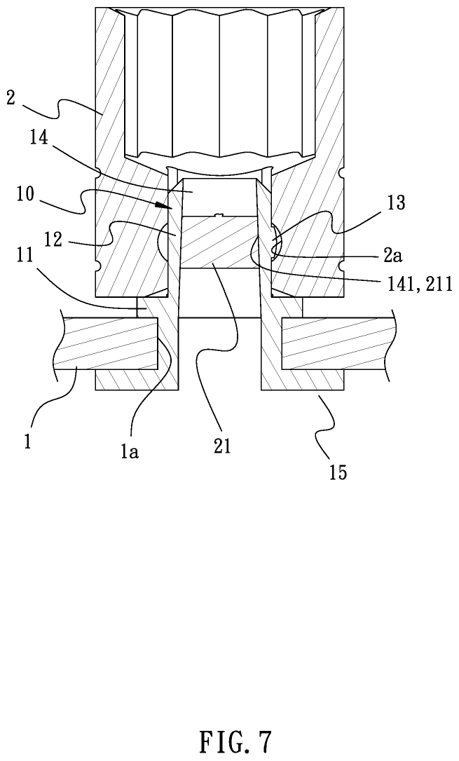

Referring to FIG. 7, finally, the operation portion 22 is twisted to break apart the connection portion 23, so that the operation portion 22 and the support portion 21 are parted from each other, thus achieving a neat appearance and an anti-theft function on the selling site.

It is noted that after the consumer purchases the socket 2, the consumer only needs to insert a screwdriver or any sharp-shaped object into the through hole 14 from the socket 2 toward the pillar 12, so as to push the support portion 21, thus moving the support portion 21 with respect to the seat 10 for remove the pressing relationship between the support portion 21 and the pillar 12. Subsequently, the socket 2 is allowed to be removed from the seat 10 for further application.

With the foregoing configuration, the socket 2 simply needs to be mounted around the seat 10, with the clamp member 20 being pulled or pushed with respect to the seat 10 for enabling the pressing relationship between the support portion 21 and the through hole 14, such that the pillar 12 stably engages with the socket 2 for achieving the anti-theft function. Also, the present invention is structurally simple and easily operated.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An anti-theft socket fixing seat for fixing a socket, comprising:
a seat having a hollow pillar disposed at one end of the seat, with a protrusion disposed at one side of the pillar, the protrusion protruding and contracting with respect to the pillar, the pillar having a through hole passing through two ends of the seat; and
a clamp member passing through the through hole, the clamp member having a support portion and an operation portion, with an end of the operation portion connected with the support portion;
when the socket is mounted around the pillar, the operation portion drives the support portion to move to a pressing portion in the through hole, such that the protrusion is engaged with an engagement groove of the socket, and the socket is unable to be detached from the pillar.

2. The anti-theft socket fixing seat of claim 1, wherein the through hole has a horizontal sectional face formed in a rectangular shape, the support portion is formed in a block having a horizontal sectional face formed in a rectangular shape, the support portion has an outer wall, and the through hole has an inner wall fitting with the outer wall.

3. The anti-theft socket fixing seat of claim 1, wherein when the clamp member passes through the through hole, an end of the operation portion away from the support portion is exposed outward from the pillar.

4. The anti-theft socket fixing seat of claim 3, wherein the operation portion is formed in an elongate sheet and connected with the support portion via a connection portion, and the operation portion is allowed to be twisted with respect to the support portion, such that the connection portion is broken apart to part the operation portion from the support portion.

5. The anti-theft socket fixing seat of claim 2, wherein the operation portion is connected with the support portion via a connection portion, and the operation portion is allowed to be twisted with respect to the support portion, such that the connection portion is broken apart to part the operation portion from the support portion; the outer wall tapers from a bottom end of the support portion toward a top end of the support portion, such that an edge of the outer wall away from the connection portion is wider than another edge of the outer wall adjacent to the connection portion.

6. The anti-theft socket fixing seat of claim 1, wherein the pillar is formed in a rectangular column, with one opening disposed on two sides of the protrusion, respectively, and the two openings are connected with the through hole.

7. The anti-theft socket fixing seat of claim 1, wherein the seat has a base plate for receiving the socket, such that the pillar extends from the base plate.

8. The anti-theft socket fixing seat of claim 1, wherein an installation portion is disposed on one end of the seat away from the pillar, and the installation portion is combined with a display body.

9. The anti-theft socket fixing seat of claim 8, wherein the display body has a bore, such that the installation portion is resiliently combined to the bore.

10. The anti-theft socket fixing seat of claim 9, wherein the installation portion comprises two symmetrical foot members that are spaced with respect to each other.
